(19) United States
(12) Patent Application Publication
(10) Pub. No.: US 2013/0000994 A1
(43) Pub. Date: Jan. 3, 2013

(54) Solar-powered hybrid vehicles

(76) Inventor: Shuyi Zhu, Ningbo City (CN)

(21) Appl. No.: 13/516,873

(22) PCT Filed: Sep. 7, 2011
(86) PCT No.: PCT/CN2011/079446

§ 371 Date: Jun. 18, 2012

(30) Foreign Application Priority Data
Jun. 8, 2011 (CN) 201110151619.9

(51) Int. Cl. B60K 16/00

(52) U.S. Cl. 180/2.2

(57) ABSTRACT

A solar-powered hybrid vehicle disclosed in the present invention comprises a vehicle body, a vehicle energy configuration system, and a brake energy recovery system. The vehicle body collects solar energy through a collection system of solar energy. The solar energy collected is stored in the vehicle energy configuration system of the vehicle. The brake energy recovery device is connected with a battery through a solar charging circuit. A sensor is provided between the vehicle energy configuration system and the battery. The body energy configure system is connected with an automatic control system, an external charging interface and an electric motor. Through the integration of a number of technical solutions, the present invention reduces energy consumption, improves the level of utilization of solar energy, and is more fashionable and fit for human use.

### TECHNICAL FIELDS

The present invention relates to a solar-powered hybrid vehicle, belonging to the field of new energy vehicle technology.

### BACKGROUND

With the rapid development of the national economy, more and more families already have or will shortly have a vehicle. However, the soaring price of the international crude oil sounds the alarm of energy shortage. The popularity of automobiles in Chinese families requires substantial technological breakthroughs in new energy powered vehicles.

At present, many domestic and foreign research institutions and companies are committed to the research of new energy powered vehicles. Among them, hybrid vehicles are products closest to maturation in the existing new energy powered vehicles. The performance of hybrid vehicles can exceed traditional fuel vehicles, but its battery level becomes a bottleneck that limits its development. So hybrid vehicles cannot completely replace fuel vehicles.

Great progress has been made in the research and development on solar vehicles. In recent years, the research in the technology of collection and conversion of solar energy has effectively improved the efficiency of solar energy absorption. The effective absorption and utilization of solar energy by the glass body of a solar vehicle affects the overall performance of the vehicle to a great extent. To this end, the use of bendable and low-emissivity glass and thin film solar cells in solar vehicles to increase the efficiency of solar energy absorption has achieved a certain effect.

Therefore, with the help of new technology, we can provide the market with better energy-saving and environmentally friendly solar-powered hybrid vehicles.

### SUMMARY

The purpose of this invention is to solve the technical problems by overcoming the deficiencies of existing technologies and providing a type of solar-powered hybrid vehicle.

To achieve the above purpose, the present invention uses the following technical schemes.

The solar-powered hybrid vehicle comprises a body of the vehicle, a collection system of solar energy, a vehicle energy configuration system, an in-vehicle automatic control system and a brake energy recovery system.

The body of the vehicle collects solar energy through the collection system of solar energy. The collected solar energy is stored in the vehicle energy configuration system. The vehicle energy configuration system as described consists of a solar charging circuit. The brake energy recovery equipment is configured to connect with the solar charging circuit and a storage battery. A sensor is provided between the vehicle energy configuration system and a storage battery. The vehicle energy configuration system is configured to connect with the in-vehicle automatic control system, an external charging interface and an electric motor respectively.

The collection system of solar energy comprises a solar skylight, heat bendable low-emissivity glass, a thin film solar cell as well as one or more wheel-associated solar panels. The solar skylight is a honeycomb shaped solar absorbance body at the top of the body of the vehicle. One or more thin film solar cells are provided below the solar skylight.

In the vehicle energy configuration system, a control unit of the power supply is connected with a light intensity detection unit, a solar energy collection unit, a energy storage unit and a vehicle electric unit, to receive a real-time light intensity signal detected by the light intensity detection unit and to control the performance of the solar energy collection unit, the energy storage unit as well as the vehicle electric unit according to the light intensity signals.

A cover of a magnetic levitation brake disc is provided outside each wheel of the vehicle; the surface of the cover of a magnetic brake disk is provided with a wheel-associated solar panel.

The brake energy recovery system is provided between a cover of a magnetic levitation brake discs and a wheel.

Compared with existing technologies, the present invention has the following positive effects.

The solar skylight, heat bendable low-emissivity glass, thin film solar cells as well as wheel-associated solar panels collect the solar energy, so the efficiency of solar collection is improved; a three-axis acceleration sensor is provided at a wheel axle of the vehicle, and retraction is automatically adjustable according to the vehicle driving conditions; shock absorbers are provided between a wheel and an axle to ensure stable performance; a wheel-associated solar panel replaces a traditional wheel arch panel, and is used on a cover of a magnetic levitation brake disc, not only to shield the body from being in contact with soil and to protect a tire effectively, but also to collect solar energy.

### BRIEF DESCRIPTION OF FIGURES

The invention is further described in detail in accordance with the figures and the embodiments.

FIG. 1 is a schematic of the overall structure of a solar-powered hybrid vehicle of the present invention.

FIG. 2 is a front view of the solar-powered hybrid vehicle.

FIG. 3 is a rear view of the solar-powered hybrid vehicle.

FIG. 4 is a schematic of the exploded view of the structure of a wheel in the solar-powered hybrid vehicle.

FIG. 5 is a principle block diagram of the powertrain of the solar-powered hybrid vehicle.

### DETAILED DESCRIPTION

The solar-powered hybrid vehicle provided in this invention comprises a vehicle body, a collection system of solar energy, a vehicle energy configuration system, an in-vehicle automatic control system and a brake energy recovery system; wherein, the body of the vehicle collects solar energy through the collection system of solar energy; the solar energy collected is stored in the vehicle energy configuration system. The vehicle energy configuration system comprises a solar charging circuit; the brake energy recovery system is configured to connect with a storage battery; the vehicle energy configuration system is connected to the in-vehicle automatic control system.

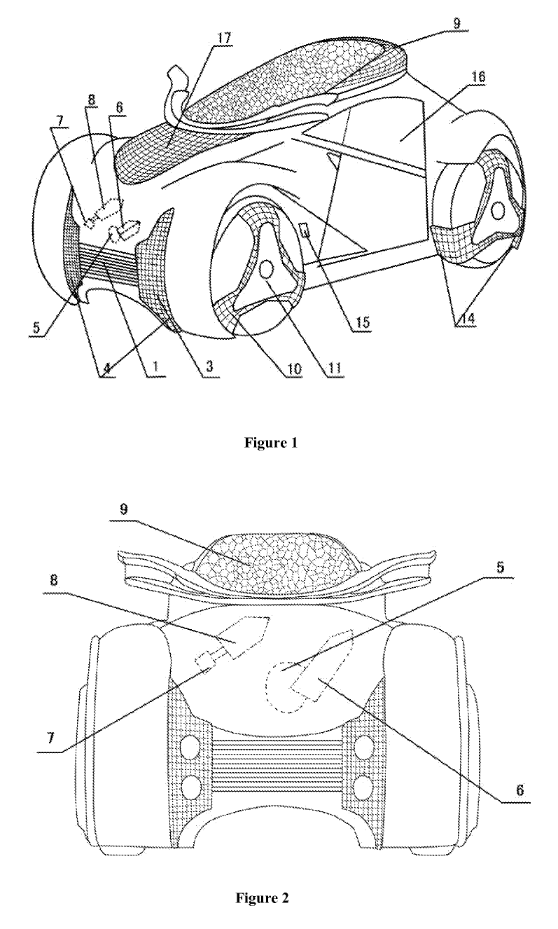

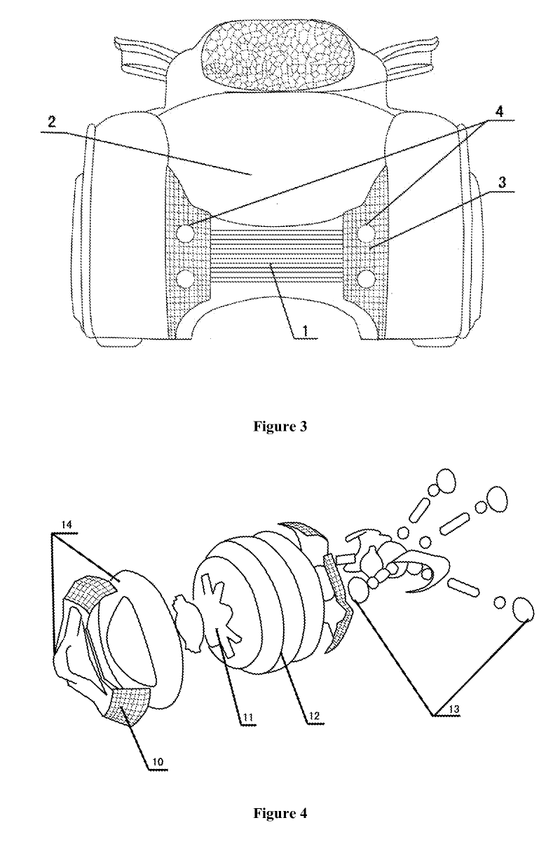

According to FIG. 1 and FIG. 2, a vent 1 is provided between the two wheels of the body of the vehicle, a radiator 2 is provided above the vent 1. The radiator 2 can assist the powertrain to cool and to extend the service life of the vehicle. Thin film solar batteries 3 are installed on both sides of the vent 1 (i.e. the vehicle surface of the two wheels). Thin film solar batteries 3 are connected to the collection system of solar energy within the body. A vehicle light 4 is provided at the location of a thin film solar cell 3.

Within the body of the vehicle, a storage battery 6, a wire 5, an electric motor 7 and a transmission 8 are provided above the radiator 2. A sensor is provided between the vehicle energy configuration system and a storage battery 6. A honeycomb shaped solar absorbance body is provided at the top of the body of the vehicle (i.e. the position of a skylight) as a solar skylight, below which is the thin film solar cell 17. The solar energy absorbed will be transformed into electrical energy through the thin film solar cell 17 and stored in the vehicle energy configuration system. A solar absorbance body 9 not only functions as a traditional skylight but also improves the absorption efficiency of solar energy, and is an important part of the collection system of solar energy.

A cover of a magnetic levitation brake disc 14 is provided outside each of the four wheels of the body of the vehicle respectively. The wheel-associated solar panel 10 and the brake energy recovery system 11 are provided on the cover of a magnetic levitation brake disc 14. The brake energy recovery system 11 is also connected with the vehicle energy configuration system. The thin film solar cell (or the wheel-associated solar panel) has the characteristics of high efficiency of solar energy collection and easy assembly, and is an important part of the collection system of solar energy. An external charging port 15 is provided at the side of the vehicle body; the vehicle energy configuration system is connected with the external charging port 15 and the electric motor 7. The heat bendable low-emissivity glass 16 is used as the window glass of the body of the vehicle, the transition layer of which is silicon oxynitride; the low-emissivity layer and an adjacent layer have sufficient ability to capture oxygen. The configuration is flexible and easy to control, which has the characteristics of high deposition and resistance to heat curving. Its transmittance efficiency of visible light is up to 76% and its solar transmittance is below 48%.

The aforementioned thin film solar cell and wheel-associated solar panels are both polycrystalline silicon photovoltaic panels based on resin. The vehicle energy configuration system transforms and configures solar energy collected by the solar skylight, heat bendable low-emissivity glass and wheels solar panels, and the excess energy will be stored in the storage battery. In the vehicle energy configuration system, the control unit of the power supply is connected with the light intensity detection unit, the solar energy collection unit, the energy storage unit and the vehicle electric unit, to receive a real-time signal detected by intensity detection unit, and to control the performance of the solar energy collection unit, the energy storage unit as well as the vehicle electric unit according to the light intensity signals.

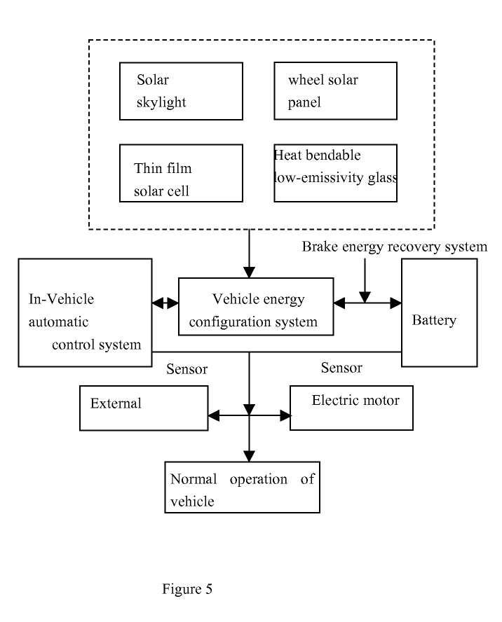

FIG. 4 is a schematic diagram of an exploded view of a wheel of the solar-powered hybrid vehicle. The cover of a magnetic levitation brake disc 14 comprises an electromagnet core, a coil, a armature, a movable friction plate component, an aluminum alloy caliper, a brake guide, spherical bearings, brake disc springs etc. It adopts the structure of connecting the electromagnets drived armature directly with the movable friction plate component; through the magnetic levitation effect and the braking effect produced by the electromagnetic force on armature, it achieves the automatic adjustment of the gap of a loose gate. Friction plate is connected with the respective components via spherical bearings, and follows the brake disc 12 automatically. The upper gate power on the cover of a magnetic levitation brake disc is produced through the brake disc spring installed within the electromagnet which acts on the movable friction disc, and thereby a constant braking force can be maintained. The brake energy recovery system 11 is provided between the cover of a magnetic levitation brake disc 14 and a wheel. The brake energy recovery system 11 is connected with the storage battery 6. When the accelerator goes back to the position of non-acceleration, the brake energy recovery system 11 will rectify the excess energy into the energy storage battery as needed, and will charge the storage battery which provides electricity to the electric motor vehicle. The recovery ratio of the charge process is more than 85%. The three-axis acceleration sensor 13 is provided at a vehicle wheel axle and its retraction is automatically adjustable according to the vehicle driving conditions. The shock absorber is provided between the wheel and the wheel axle to ensure the stable performance of the body of the vehicle. Wheel-associated solar panels are used on the cover of the magnetic levitation brake disc instead of the traditional wheel arch panels, not only to shield the body from being in contact with soil and to protect a tire effectively, but also to collect solar energy.

FIG. 5 is a principle block diagram of the powertrain of the solar-powered hybrid vehicle. The collection system of solar energy comprises a solar sunroof (i.e. a solar absorbance body), a heat bendable low-emissivity coated glass, a thin film solar cell and wheel-associated solar panels; solar energy collected is distributed into the vehicle energy configuration system; the energy disposal is vehicleried out by an in-vehicle automatic control system. Based on the actual situation, the solar-powered hybrid vehicle directs and adopts a combination use of an electric engine and an internal combustion engine to meet the actual demand. In addition, by connecting the brake energy recovery system with the storage battery, when the accelerator returns to the position of non-acceleration, brake energy recovery will rectify the excess energy into the energy storage battery as needed, and will charge the storage battery which provides electricity to the electric motor vehicle. During operation, the solar-powered hybrid vehicle can feedback the status to the in-vehicle automatic control system through the sensor, and the in-vehicle automatic control system issues the next operating instruction.

In the collection system of solar energy, when light shines on the surface of the solar panel array, some photons are absorbed by a silicon material; the energy of these photons transfers to the silicon atoms, which induces the electron transition; the electrons become free electrons and form junction potential by aggregating on both sides of a P-N junction; when an external circuit is connected, current flows through the external circuit to produce a certain output power under the effect of voltage. The essence of this process is that the energy of photons transforms into electrical energy.

The supply of electrical energy in the disclosed solar-powered hybrid vehicle comes from charging by two kinds of power sources—solar photovoltaic cells and an external power supply. When the solar photovoltaic cells produce electricity, the solar photovoltaic cells are connected with the vehicle energy configuration system and the automatic control system, and then connected with a load at the other end. The load is the electric motor of the solar-powered hybrid vehicle (a vehicle drive device). While the solar-powered hybrid vehicle is running, the energy converted from sunlight is directly transferred to the load through the vehicle energy configuration system; but when the vehicle is not running or when there is an abundance of sunlight, the rest of the electrical energy charges the storage battery through the solar cell charging circuit and is stored; when there is insufficient sunlight, both the solar photovoltaic cells and the storage battery charge the load at the same time. When the vehicle decelerates or brakes, the brake energy recovery system converts the mechanical energy into electrical energy, and charges the storage battery in reverse to store the energy. This complementary and uninterrupted solar power supply method avoids relying on the weather too heavily, which is a defect of existing solar vehicles, and improves the dynamic performance of the solar-powered hybrid vehicle.

The voltage supplied by the solar photovoltaic cells is basically equal to the saturation voltage of the storage battery, and it can be coupled directly. When the output power of the solar photovoltaic cells is sufficient, any excess energy will enter the storage battery for storage; when the output power of the solar photovoltaic cells is insufficient, the task of the electric drive will be completed by the storage battery. The above control process is controlled by the in-vehicle automatic control system. The function of the in-vehicle automatic control system is to control the process of charging and discharging, to ensure that the powertrain charges, discharges and drives the solar-powered hybrid vehicle normally.

With respect to the appearance of the vehicle body of the disclosed solar-powered hybrid vehicle, the wheels at the other side of a turning direction of the vehicle can stretch out when turning, enabling the vehicle to have a big turn; in addition, great improvements have been made in the size, color, degree of streamline and level of comfort of the vehicle, and the vehicle is more suitable for fitting the needs of future consumers. In addition, the shell of the solar-powered hybrid vehicles adopts a nano-coating paint, such as nano-zinc oxide particles or gold nanoparticles, which makes the appearance more shinny and resistant to erosion. The antimicrobial and decontamination character of nanoparticles can make the inner decoration clean and healthy.

Through the combination of the above techniques, the present invention not only reduces energy consumption, improves the level of utilization of solar energy, but also improves the vehicle appearance and fit for human use. The solar-powered hybrid vehicle not only reduces an maintenance cost, but also conforms with the energy saving policy issued by the State and will bring tangible benefits for the drivers in the future market.

Therefore, the present invention has the following advantages: higher utilization ratio of solar energy, less consumption of fuel or gas, more environmentally friendly and low-vehiclebon, more stable running, more durable tires, and more fashionable appearance.

Above is a preferred embodiment of the present invention. It should be noted that for the ordinary technician in this field, under the premise of non-escaping the inventive concept, Improvements and decoration can also be made, which should also be regarded as within the scope of protection of the present invention.

1. A solar-powered hybrid vehicle, comprising a body of the vehicle, a collection system of solar energy, a vehicle energy configuration system, an in-vehicle automatic control system and a brake energy recovery system; wherein the vehicle has the following characteristics:
the body of the vehicle collects solar energy through the collection system of solar energy; the solar energy collected is stored in the vehicle energy configuration system; the vehicle energy configuration system is configured to connect with the in-vehicle automatic control system, an external charging interface and an electric motor respectively;
the collection system of solar energy comprises a solar skylight, heat bendable low-emissivity glass, a thin film solar cell and one or more wheel-associated solar panels; the solar skylight is a honeycomb shaped solar absorbance body at the top of the body of the vehicle; one or more thin film solar cells are provided at the bottom of the solar skylight;
a vent is provided between the two wheels of the body of the vehicle; a radiator is provided above the vent; thin film solar cells are installed on both sides of the vent; an electric motor and a transmission are provide above the radiator inside the body of the vehicle;
in the vehicle energy configuration system, a control unit of the power supply is connected with a light intensity detection unit, a solar energy collection unit, a energy storage unit and a vehicle electric unit, to receive a real-time light intensity signal detected by the light intensity detection unit and to control the performance of the solar energy collection unit, the energy storage unit as well as the vehicle electric unit according to the light intensity signals;
a cover of a magnetic levitation brake disc is provided outside each wheel of the vehicle respectively; the surface of the cover of a magnetic levitation brake disc is provided with a wheel-associated solar panel;
the brake energy recovery system is provided between a cover of the magnetic levitation brake disc and a wheel; the brake energy recovery system is configured to connect with a storage battery; sensors are provided between the body energy configuration system and the storage battery.

2. The solar-powered hybrid vehicles of claim 1, with the following characteristics: a three-axis acceleration sensor is provided at a wheel axle of the vehicle; a shock absorber is provided between a wheel and a wheel axle.

3. A solar-powered hybrid vehicle, comprising a body of the vehicle, a collection system of solar energy, a vehicle energy configuration system, an in-vehicle automatic control system and a brake energy recovery system, wherein the vehicle has the following characteristics:
the body of the vehicle collects solar energy through the collection system of solar energy; the solar energy collected is stored in the vehicle energy configuration system; the brake energy recovery system is connected with a storage battery; one or more sensors are provided between the brake energy recovery system and the storage battery; the vehicle energy configuration system is configured to connect with an in-vehicle automatic control system, an external charging interface and an electric motor respectively.

4. The solar-powered hybrid vehicle of claim 3, with the following characteristics:
said collection system of solar energy comprises a solar skylight, heat bendable low-emissivity glass, a thin film solar cell and one or more wheel-associated solar panels; wherein the solar skylight is a solar absorbance body at the top of the vehicle.

5. The solar-powered hybrid vehicle of claim 3, with the following characteristics:
in the vehicle energy configuration system, a control unit of a power supply is connected with a light intensity detection unit, a solar energy collection unit, an energy storage unit and a vehicle electric unit, to receive a real-time light intensity signal detected by the light intensity detection unit and to control the performance of the solar energy collection unit, the energy storage unit as well as the vehicle electric unit according to the light intensity signals.

6. The solar-powered hybrid vehicle of claim 3, with the following characteristics: a three-axis acceleration sensor is provided at a wheel axle of the vehicle.

7. The solar-powered hybrid vehicle of claim 3, with the following characteristics: a shock absorber is provided between a wheel and a wheel axle.

8. The solar-powered hybrid vehicle of claim 3, with the following characteristics: a cover of a magnetic levitation brake disc is provided outside a wheel of the vehicle; the surface of the cover of a magnetic levitation brake disc is provided with a wheel-associated solar panel.

9. The solar-powered hybrid vehicle of claim 3, with the following characteristics: a brake energy recovery system is provided between a cover of a magnetic levitation brake discs and a wheel.

10. The solar-powered hybrid vehicle of claim 3, with the following characteristics: a shell of the solar-powered hybrid vehicles adopts a nano-coating paint.
